(19) United States
(12) Patent Application Publication
(10) Pub. No.: US 2005/0008995 A1
(43) Pub. Date: Jan. 13, 2005

(54) Reading aid

(76) Inventor: Herbert Prah, Maribor (SI)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/911,805

(22) Filed: Aug. 5, 2004

Related U.S. Application Data
(63) Continuation of application No. PCT/IB03/00375, filed on Feb. 5, 2003.

(30) Foreign Application Priority Data
Feb. 8, 2002 (CH) 215/02

(51) Int. Cl. G09B 1/00; G09B 19/00

(52) U.S. Cl. 434/167

(57) ABSTRACT

The process is based upon the observation that, in a text, mainly the consonants are the carriers of vital information, while vowels, serve merely as a connection between them; in other words, consonants carry 80-90% of the information, while vowels carry merely 10-20%. However, through their repeating appearance, the vowels take up almost half of the space in a text, so that their actual contribution in respect to the visual appearance is out of proportion. The solution is to print the consonants with black ink, and with a relative coverage of, for example: 100, on white paper, and then vowels with a coverage of, for example: 50-70, therefore weaker, the text becomes thus markedly, faster, better, and easier to read. The degree of coverage can also be seen in form of optical weight, for example, that the vowels take up merely ⅔ of the visual weight of the consonants.

### CROSS-REFERENCE TO RELATED APPLICATIONS

This application is a Continuation of International Application PCT/IB03/00375 filed on Feb. 5, 2003, which designated the U.S., and which is hereby incorporated herein in its entirety by reference.

### BACKGROUND OF THE INVENTION

1. Field of the Invention

The invention lies in the area of reading aids, and concerns a procedure which facilitates the production of texts, which are quicker and less-tiring to read. This pertains, in particular, to texts appearing on a display or projection screen; however, also texts printed in this novel fashion show a marked improvement in reading comfort.

2. Discussion of Related Art

The invention is based on the observation that the consonants are the main carrier of information, whilst the main function of vowels is that of connecting consonants. In other words, consonants carry 80-90% of the information, leaving the rest 10-20% to the vowels. However, in the average, vowels take up a good half of the text; therefore their part of the visual impression is over-proportional.

The aim, however, is to optimally adjust the proportion between essential textual information, and its visual appearance. This invention makes this possible.

### BRIEF SUMMARY OF THE INVENTION

A font (a letter) is a symbol which covers a given amount of white surface with a predetermined amount of black coverage, in a given shape or form. This area covered, varies from letter to letter. The letter “i” covers less of the white background surface, than, for example the letters “w” or “m”. The vowels “a, e, i, o, u” have, with the exception of the letter “i”, roughly the same degree of coverage. However, in the case of consonants, the degree of coverage greatly varies.

It we print black consonants in a relatively high degree of intensity of 100, the white surface (AF), and vowels also in black, on the same surface AF, in an intensity of 50-70, therefore lighter, that is to say weaker, the text appears noticeably easier to read. The degree of coverage, can also influence to visual effect—this as either a function/ratio of the intensity, or visual density (AI). Generally speaking, we can consider the degree of coverage and density AF and AI, as visual weights or visual intensity. For example: the vowels are thereby allowed but ⅔ of the weight of the consonants, and thus the text becomes easier to read.

This procedure is applicable to any font, whether a serif or non-serif typeface. The serif in any given type is functionally merely a variation of the design of the typeface, while our procedure is not based on any design concept, but rather, establishes a novel solution, and this is new. The reading aid is achieved through visual intensity, and the application of different degrees of this intensity. The different degree of intensity can be achieved through coverage with the same color, or through scaling of the same color.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1: shows two letters “I”, referring to the degree of coverage, as a function of the surface AF, strictly schematically, in a ratio of 1:0, 7.

FIG. 2: shows two further letters “I”, referring to the degree of coverage, hatched, as function of the intensity AI, also, presented schematically, in a ratio of 1:0, 7.

FIG. 3: shows the letter “I”, where both functions of the degree of coverage AI and AF, are included in the visual weighting, which is presented through the combination operator AI*AF.

FIG. 4: shows in an overall principal diagram how the solution and its realization can be achieved.

FIG. 5: shows the overall principal diagram, with switches A to D, which activate and deactivate sensors and/or other, to achieve various and desired working conditions.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

These five examples practically cover all that is necessary in order to apply the procedure either, additively, with printing colors, for example on paper, or transmissively, projecting on a display or a screen. The intensity through surface coverage is achievable, for example through vectorizing, and intensity through density is, for example achievable through down scaling (neutral wedge key). Obviously, there are also other methods of approach available, to achieve the same goal; in this particular case, an easy to follow applicable example has been chosen.

The example in FIG. 1 shows a vectorized font, with the so called handles, here D representing the thickness, and L the length. To facilitate the transformation from 1 to 0,7, handle D is moved to 70%. This procedure is known, and regularly used in image depiction. It should be mentioned, that with this procedure, the character of the font is not changed, it generally corresponds to the transformation of the font—smaller—larger pica.

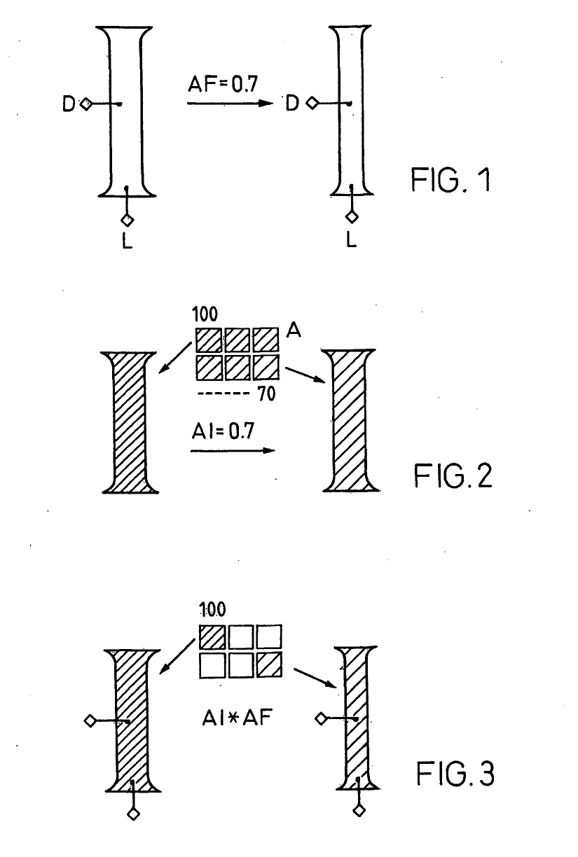

The example in FIG. 2 shows a font, for example a bitmap font, which is provided with a scale “A”, in which, for example the color black has been downgraded from black through grays to white. This obviously applies to other colors as well. After designating the area with a 70% gray intensity, the font I=100 transforms to I=70. This procedure is known as well, and is used in TV displays, and computer screens. Also here, the character of the font is not changed, and remains the same—for example: Times Roman, Arial, and others.

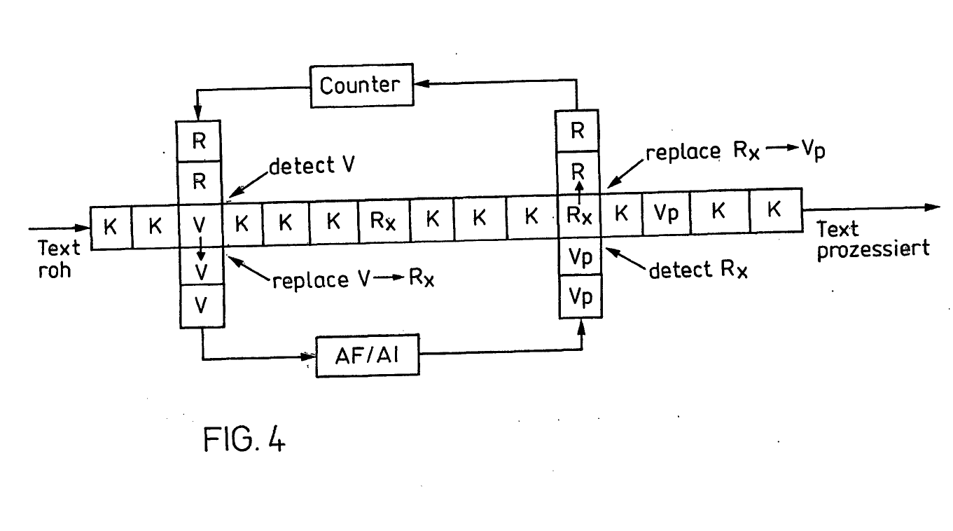

The example in FIG. 3 shows the combination of both procedures, described above. One can proceed gradually, by first narrowing the font, and then degrading the intensity. This procedure will be applied in cases when the desired transformation of the covering intensity, respectively the surface, for example: transformation as per AF approach, creates a slightly irritating text, which could be the case with certain specific fonts. In this case, a certain amount of surface coverage is “sacrificed” in order to achieve a cleaner look, correcting with the covering intensity AI. In this manner, most of the approximately 1000 existing fonts today can be satisfactorily processed. For this purpose, for example: a library, can be provided with a number of established combinations, which are cross-indexed and filed, therefore allowing for a text to be automatically assigned the necessary combination.

FIG. 4 shows abstractly in form of intertwined (interconnected) shift-registers and base functions, sensors, activators, converters, switches, etc., how the transposition of the text could be achieved. The basic text is entered (or fed) into a horizontal shift register, consisting of consonants K, and vowels V; at a first detecting position for vowels (V) (Detector), and simultaneous replacement of same (activator) through the indicated place-saver Rₓ, the vowel will thus be directed to the conversion function AF/AI, and after AF or AI, or AF*AI transformed. The processed vowels Vp, land at a further, here a second detection position marked space-saver Rₓ, to be replaced there by the processed vowel Vp, so that the vowels return to their original position in the text, and the text can be emitted as a processed text. The space-savers and the positions will be regulated, for example: through a counter. The control system can, of course, be designed in other further ways, also, for each of the five vowels a, e, i, o, u, as well as the other non-consonant symbols, a detection and space-saver position can be provided for.

The herewith discussed diagrammed scheme has been presented in its simplest form.

The fixed order, namely, the detection of the vowels, or other non-consonant symbols, which perform the same or similar functions, and their replacement with indicated space-savers, so long as these symbols are transformed, in order to be able to be integrated once again into the text, offers the possibility of a speedier transformation of a given text. This is of importance, when it concerns the projected image of a text, where a reader may wish to choose and switch between both modi.

On the display, many texts are not read overly attentively, as reading the projected/transmitted text image is tiring. If a “button” is provided on the projected/transmitted text images, for example: in the Internet texts, as seen on the display, with the original unprocessed text, either processed unto a conversion device such as shown in FIG. 4, or left in its original state or form, a text can be switched/plugged to be easier to read, then to be returned to its original form, and when, in conjunction with such a switch, the parameters of the conversion can be influenced, every one is able to choose and personally adjust the most comfortable form of typeface and text representation.

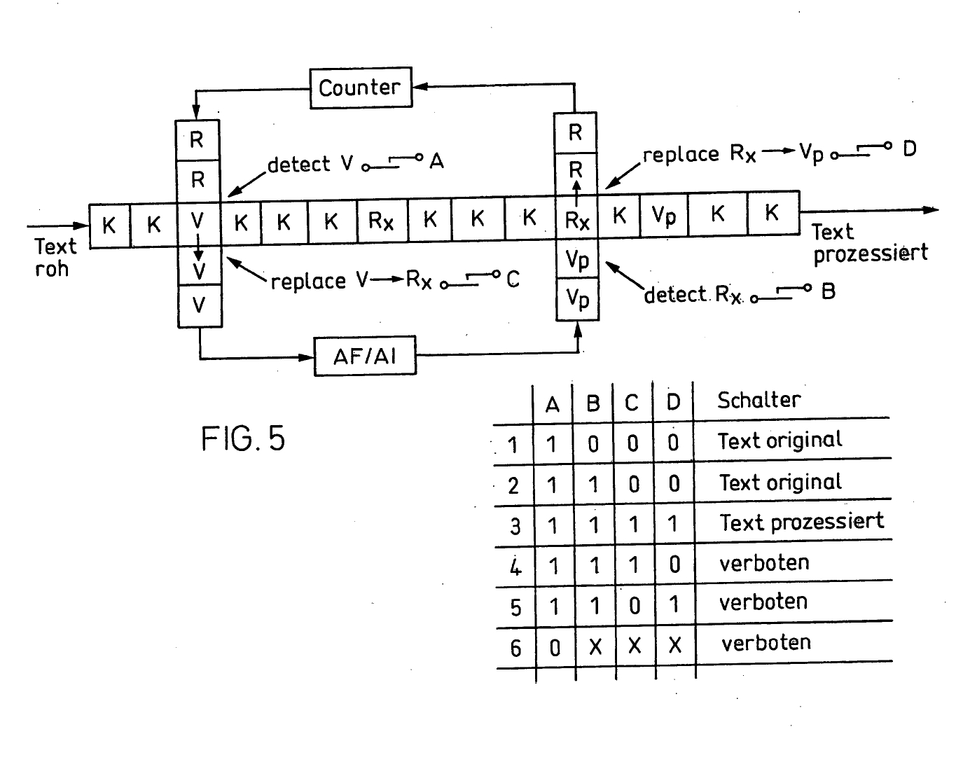

Such an application is shown in FIG. 5, where each sensor and activator has been designated an A to D switch. Actually, it would suffice to only turn on and off the activators in order to display/transmit an original or processed text. If, however, the sensors are equipped with switches, (or are switchable) one has the possibility to activate or deactivate special effects for individual vowels. The chart (“the button”) FIG. 5, shows functions 1-6, which leave the text unchanged, as well as are able to change the text, and those which are forbidden, as they could affect undefined operational conditions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. Procedure for the establishment of a reading aid for printed text appearing on media, wherein vowels and other non-consonant symbols in the text appear with a different intensity than that of the consonants.

2. Procedure as per claim 1, wherein the vowels and other non-consonant symbols of the text appear with a weaker intensity than the intensity of the consonants.

3. Procedure as per claim 1, wherein a difference in intensity between the appearance of vowels and other non-consonant symbols and the consonants is a ratio in the range of 1:0,8-0,5.

4. Procedure as per claim 1, wherein the vowels appear with an intensity that is 70% of the intensity with which the consonants appear.

5. Procedure as per claim 1, wherein said text appears on media in the form of at least one of paper, metal, and plastic.

6. Procedures as per claim 1, wherein said text appears on media in the form of electronically projected or transmitted text on a display.

7. Procedure as per claim 1, wherein the intensity value defines an optical weight of the text printed, wherein vowels and other non-consonant symbols in the text appear with a lower optical weight than consonants.

8. Procedure as per claim 1, wherein the intensity value represents the size that the text is printed, wherein vowels and other non-consonant symbols in the text are condensed in size compared to the consonants.

9. Procedure as per claim 1, wherein the intensity value is a combination of both an optical weight of the text printed and a size of the text printed, wherein vowels and other non-consonant symbols in the text appear with at least one of a lower optical weight and smaller size than consonants.

10. A method for printing text having at least consonant and vowel characters on a media comprising:
printing vowel characters of the text on the media with a first intensity; and
printing consonant characters of the text on the media with a second intensity,
wherein said first and second intensities are different values.

11. A method according to claim 10 further comprising printing non-consonant characters of the text on the media with the first intensity.

12. A method according to claim 10, wherein said printing vowels step comprises printing the vowel characters with a first intensity that is less than the second intensity.

13. A method according to claim 10, wherein said printing vowel characters step comprises printing the vowel characters with a first intensity that is less than the second intensity, where the ratio of intensities between the first and second intensities is a ratio in the range of 1:0,8-0,5.

14. A method according to claim 10, wherein said printing vowel characters step comprises printing the vowels with a first intensity that is 70% of the second intensity.

15. A method according to claim 10, wherein both of said printing steps print the text on a media in the form of at least one of paper, metal, and plastic.

16. A method according to claim 10, wherein both of said printing steps print the text on a media in the form of electronically projected or transmitted text on a display.

17. A method according to claim 10, wherein the intensity with which the character is printed is at least one of a white surface (AF) and visual density (AI) of the character.

18. A method according to claim 10, wherein the intensity value defines an optical weight of the text printed, wherein said printing vowels step prints vowels with a lower optical weight than consonants are printed.

19. A method according to claim 10, wherein the intensity value represents the size of the text, wherein said printing vowels step prints vowels in a size smaller than the consonants are printed.

20. A method according to claim 10, wherein the intensity value is a combination of both an optical weight of the text printed and a size of the text printed, wherein said printing vowels step prints vowels with at least one of a lower optical weight and a smaller size than consonants are printed.

21. A device for converting text into a desired displayable form comprising:
a plurality of memory registers, each register storing a character of the text;
a detection device connected to said registers to detect characters of the text that are non-consonants; and
a conversion unit in communication with said detection device for altering the intensity with which the non-consonant characters are displayed.

22. A device according to claim 21, wherein said conversion unit converts at least one of a white surface (AF) and visual density (AI) of the non-consonant character.

23. A device according to claim 21, wherein the characters of text are shifted through memory registers, said device further comprising an insertion device for inserting a place saver in the memory register associated with the non-consonant character to indicate the location in the text of the character while said conversion unit converts the non-consonant character to a converted character.

24. A device according to claim 21 further comprising a detector for detecting the place saver inserted by the insertion device and replacing the place saver with the converted character.

25. A device according to claim 21 further comprising at least one switch in connection with at least one of said detector and conversion unit for selectively enabling said detector and conversion unit so that a conversion operation can be selected.

26. A method for converting text into a desired displayable form where the individual characters of the text are being shifted in memory registers, said method comprising:
detecting characters of the text that are non-consonants; and
altering the intensity with which the non-consonant characters are displayed relative to the intensity with which consonants are displayed.

27. A method according to claim 26, wherein said converting step converts at least one of a white surface (AF) and visual density (AI) of the non-consonant character.

28. A method according to claim 26, wherein the intensity value defines an optical weight of the text printed, wherein said altering step alters the vowels to have a lower optical weight when printed than the consonants are printed.

29. A method according to claim 26, wherein the intensity value represents the size of the text, wherein said altering step alters the vowels to have a size when printed that is smaller than the consonants are when printed

30. A method according to claim 26, wherein the intensity value is a combination of both an optical weight of the text printed and a size of the text printed, wherein said altering step alters the vowels to have at least one of a lower optical weight and a smaller size than consonants when printed.

31. A method according to claim 26 further comprising inserting a place saver in the memory register associated with the non-consonant character to indicate the location in the text of the character while said converting step converts the non-consonant character to a converted character.

32. A method according to claim 26 further comprising detecting the place saver inserted by the insertion device and replacing the place saver with the converted character.

33. A method according to claim 26 further comprising selectively enabling said conversion step.

34. A typeface produced by the method according to claim 1.
